(19) United States
(12) Patent Application Publication
(10) Pub. No.: US 2015/0127930 A1
(43) Pub. Date: May 7, 2015

(54) AUTHENTICATED DEVICE INITIALIZATION

(71) Applicant: Seagate Technology LLC, Cupertino, CA (US)

(72) Inventors: Manuel A. Offenberg, San Francisco, CA (US); Anthony R. Duran, Longmont, CO (US); Graham D. Ferris, Burnsville, MN (US); Monty A. Forehand, Loveland, CO (US)

(73) Assignee: Seagate Technology LLC, Cupertino, CA (US)

(21) Appl. No.: 14/073,034

(22) Filed: Nov. 6, 2013

(51) Int. Cl. G06F 21/57

(52) U.S. Cl. CPC G06F 21/572
USPC 713/2

(57) ABSTRACT

Apparatus and method for performing authentication processing during device initialization. In accordance with some embodiments, a data storage device has a main memory which stores user data from a host, and a controller with initialization programming stored in a boot memory. The initialization programming is executed by the controller to transition the data storage device from an inactive state to a normal operational mode. During a bootstrap mode, the controller generates a first authentication token, receives a second authentication token responsive to the first authentication token, and authorizes use of new system programming responsive to the second authentication token. The new system programming is stored in a local memory of the data storage device and executed by the controller during the normal operational mode.

### SUMMARY

Various embodiments of the present invention are generally directed to authentication actions that are taken during the initialization of a device.

In accordance with some embodiments, a data storage device has a main memory which stores user data from a host, and a controller with initialization programming stored in a boot memory. The initialization programming is executed by the controller to transition the data storage device from an inactive state to a normal operational mode. During a bootstrap mode, the controller generates a first authentication token, receives a second authentication token responsive to the first authentication token, and authorizes use of new system programming responsive to the second authentication token. The new system programming is stored in a local memory of the data storage device and executed by the controller during the normal operational mode.

These and other features and advantages which characterize the various embodiments of the present invention can be understood in view of the following detailed discussion and the accompanying drawings.

### BRIEF DESCRIPTION OF THE DRAWINGS

FIG. 1 is a generalized functional representation of an exemplary data storage device operated in accordance with various embodiments of the present invention.

FIG. 2 is an exemplary functional block diagram of aspects of the device of FIG. 1.

FIG. 3 is a flow chart for a BOOT PROCESS routine in accordance with some embodiments.

FIG. 4 is a functional block diagram of the device of FIG. 1 in conjunction with a host and a secure server.

FIG. 5 is a sequence diagram illustrating steps carried out during an authentication sequence of FIG. 4.

FIG. 6 is a flow chart for an AUTHENTICATION PROCESSING routine in accordance with some embodiments.

### DETAILED DESCRIPTION

The present disclosure generally relates to data security, such as in the context of protecting user data in a data storage device.

Data encryption can be employed to reduce the ability of an unauthorized party to access stored data. Encryption generally involves the transformation of an input data sequence (plaintext) to an encrypted output data sequence (cyphertext) using a selected encryption algorithm (cipher). A cipher utilizes one or more pieces of auxiliary data (e.g. keys) to effect the transformation to ciphertext (e.g., to generate encrypted data). The ciphertext may be subsequently decrypted using the cipher and the key(s) to return the original plaintext data.

Some types of data storage devices are configured to encrypt user data received from a host and to store the encrypted data in a main memory, such as rotatable recording media (e.g., magnetic discs), solid-state memory (e.g., flash), etc. Data storage devices may include a programmable controller with associated firmware to direct overall operation of the device, including data encryption and decryption operations. The firmware may be stored in the main memory or elsewhere within the device and loaded to a local memory during an initialization, or boot operation in which the device is transitioned from an inactive state to an active state.

A boot operation often relies on boot code that is automatically executed by the controller upon device initialization. The boot code may be stored in a special boot read only memory (boot ROM). When executed, the boot code initiates a boot sequence that may include various steps such as the testing of registers and other components, the loading of parameters and other control information, the loading of firmware to local memory, and the transition of the system to normal operation. Once the system firmware takes over, the boot code is not used until the next initialization of the system in which case the foregoing sequence is repeated.

Some boot sequences include a so-called bootstrap mode. A bootstrap mode temporarily interrupts the boot sequence to allow user selection of one or more administrative tasks, such as downloading new firmware to the device, etc. The bootstrap mode can be activated in a variety of ways depending upon the configuration of the system. In the context of a data storage device, bootstrap mode can be enacted through physical manipulation of a bootstrap selection mechanism, such as by placing a conductive jumper across a pair of connector pins on the device.

While bootstrap mode functionality provides an efficient mechanism for authorized agents to interact with the configuration of a data storage device, in some cases it can also provide a window of opportunity for an unauthorized party to gain access to the device for malicious purposes.

For example, an attacker having physical possession of a data storage device might attempt to force the device into a bootstrap mode and then download malicious firmware to the device designed to gain access to control aspects of the encryption system that protects the user data stored by the device. Even if access to the encrypted user data is not the goal, an unsecured bootstrap mode can allow an attacker to cause other problems with the device, potentially corrupting or otherwise placing the device into an unusable condition.

Accordingly, various embodiments of the present disclosure are generally directed to an apparatus and method for performing authentication during device initialization operations, such as during a bootstrap mode of operation of a data storage device. As explained below in greater detail, an example storage device includes a programmable controller that uses programming in the form of firmware during normal device operation to transfer user data between a host and a main memory. In some cases, the user data may be encrypted by the device prior to storage in the main memory.

The controller uses specially configured programming (boot code) during an initialization (boot) sequence in which the device transitions from a deactivated state to an operational state. The boot code includes bootstrap mode functionality whereby the boot sequence can be interrupted to allow a user to perform one or more administrative actions, including the downloading of new firmware for the controller from a host device.

If bootstrap mode is activated, the boot sequence proceeds with an authentication processing routine before permitting at least certain functions to be carried out during the bootstrap mode. The authentication processing includes the generation of a challenge value before accepting or loading new controller firmware. The challenge value may be generated automatically, or may be generated in response to a request by the host device.

The challenge value, also sometimes referred to as a storage device verification token, is forwarded to the host which in turn forwards the challenge value and host identification (ID) information (host device verification token) to a remote secure server. The host device verification token may be subjected to cryptographic processing by the host, such as through the application of encryption, a digital signature, etc.

The secure server returns a digitally signed challenge value (secure server verification token) to the host, which forwards the same to the storage device. The controller uses the digitally signed challenge value to authenticate the storage server, and subsequently accepts and loads replacement programming for the controller. In some cases, the communications between the host and the secure server may be transmitted using a secure data communication channel established through the network.

In this way, the secure server authenticates the storage device and the host, and the storage device authenticates the secure server. Unauthorized changes to the system firmware of the data storage device can be reduced, and potential attacks upon the security of the data stored by the device can be thwarted. Other attempted system configuration changes to the data storage device can also be protected by this authentication processing.

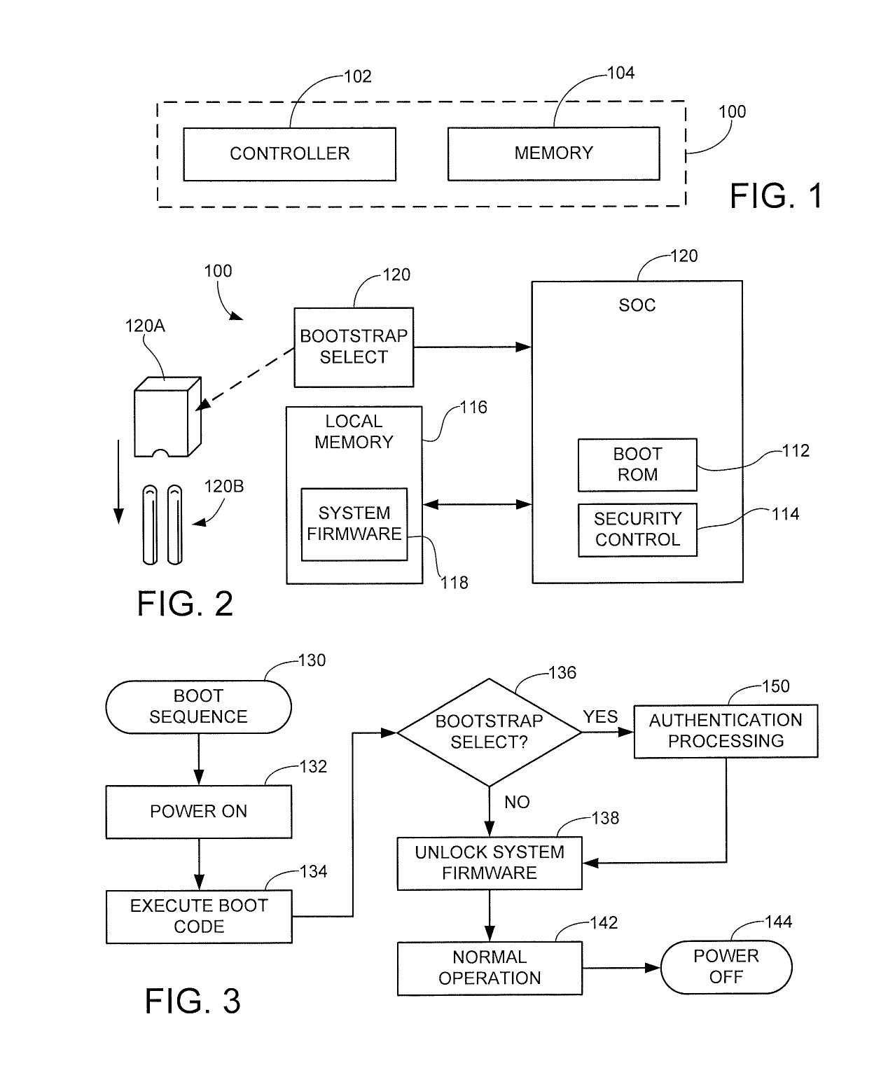

These and other features of various embodiments of the present disclosure can be understood beginning with a review of FIG. 1 which shows a simplified block diagram for a data storage device 100. The device 100 includes a top level controller 102 and a memory module 104. The controller 102 may be programmable or hardware based and directs I/O operations with a host device (not shown in FIG. 1). The controller 102 may be a separate component or may be incorporated directly into the memory module 104.

It is contemplated that the device 100 constitutes a hard disc drive (HDD) with rotatable recording media, a solid-state drive (SSD) with non-volatile solid-state media (e.g., flash memory), a hybrid drive with both rotatable and solid-state media, etc.

FIG. 2 shows aspects of the device 100 of FIG. 1 in accordance with some embodiments. A system on chip (SOC) 110 houses the controller 102 and other aspects of the system and constitutes one or more integrated circuits (such as an application specific integrated circuit, ASIC) encapsulated into a chip package. The SOC 110 incorporates a variety of operational elements, including a boot random access memory (boot ROM) 112 which stores boot (initialization) code used by the controller during device initialization to execute a boot sequence. A security control module 114 performs authentication processing during the boot sequence.

The SOC 110 communicates with a local memory 116 to which is loaded system firmware (FW) 118. The controller uses the system FW 118 once the boot sequence transitions to a normal mode of operation. The system FW 118 may be stored in the main memory 104 (FIG. 1) or elsewhere in the system and loaded during the boot process.

FIG. 2 further shows a bootstrap select mechanism 120 which is operatively coupled to the SOC 110. The bootstrap select mechanism 120 can take a variety of forms and generally comprises a mechanical switch or other physical component of the storage device 100 that can be manipulated by a user of the device to activate a bootstrap mode.

While not limiting, it is contemplated that the bootstrap select mechanism 120 may comprise a conductive jumper 120A that can be placed onto a pair of adjacent connector pins 120B to select the bootstrap mode. Other forms of bootstrap mode activation can be employed, including activation carried out through commands entered through an interface coupled to the storage device 100, etc.

FIG. 3 is a generalized flowchart for a BOOT SEQUENCE routine 130 carried out by the storage device 100 in accordance with some embodiments to transition the device from a deactivated state to an operationally ready state. The routine 130 is merely exemplary and various steps can be added, modified, omitted, performed in a different order, and so on depending on the requirements of a given application.

The routine 130 begins with a detected power on indication at step 132. The power on indication may result from the application of system power to the device, a soft or hard reboot of the device (or an associated host with which the device is associated), etc. The power on detection initiates a reset of the SOC 120 and initiation of the execution of the boot code stored in the boot ROM 112 (FIG. 2) at step 134. The execution of the boot code at step 134 will result in various system initialization steps to prepare the device for normal operation.

Decision step 136 determines whether a bootstrap select signal is detected during the boot sequence. If not, the boot sequence will load and run the system firmware 118 at step 138, which may include the transfer of such firmware to the local memory 116

(FIG. 2) and authorization of the use thereof by the system. The device 100 then enters normal operation as indicated at step 142, during which the device operates in accordance with the programming supplied by the system firmware 118 to service data access commands with a host device. Normal operation continues until a power off indication is received at step 144, which transitions the device to an inactive state. The power off condition may be a hard power off situation wherein the device is turned off (inadvertently or intentionally), a soft reboot operation in which the controller is reinitialized, etc.

At such time that a bootstrap select signal is detected at step 136, the routine passes to an authentication processing block 150. The authentication processing block 150 will be discussed in greater detail below, but at this point it will be understood that the block serves to verify that the bootstrap selection was carried out by an authorized agent, and any actions taken during the bootstrap mode to change the configuration of the data storage device are authorized.

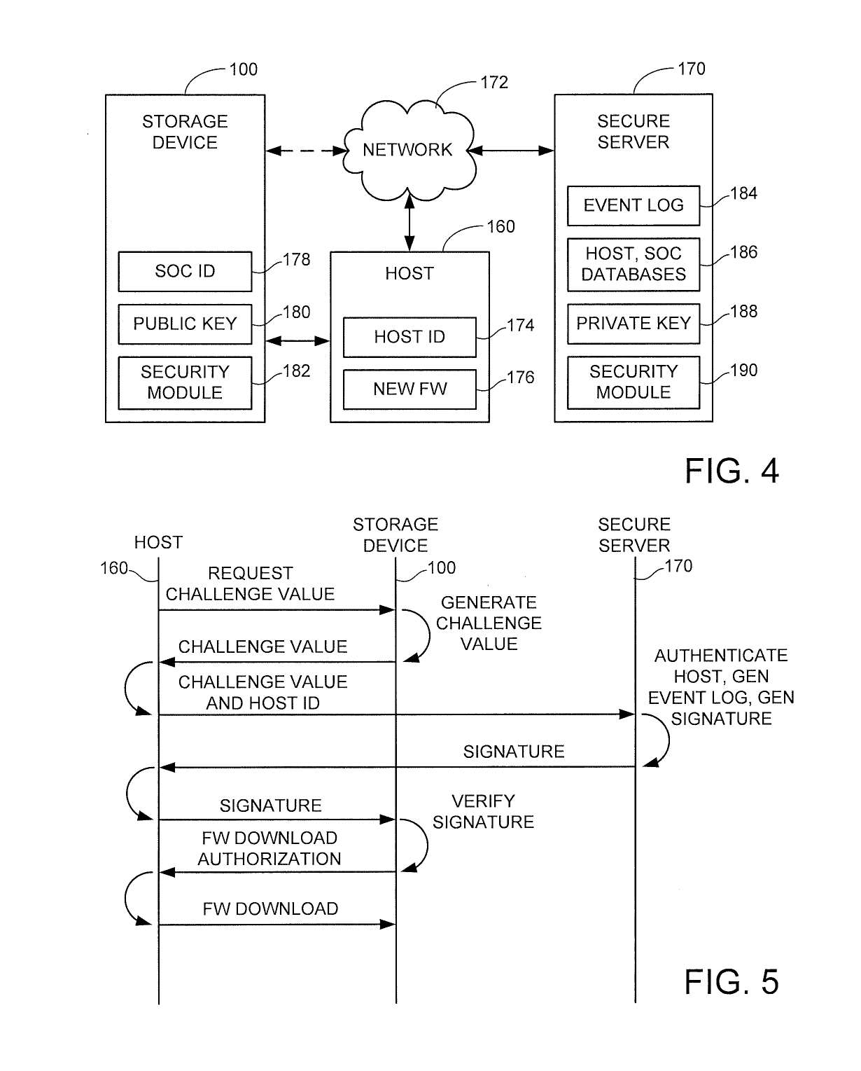

FIG. 4 is a functional block diagram of the data storage device 100 in conjunction with a host 160 and a secure server 170. These respective elements may communicate via a computer network 172, such as a local area network (LAN), a wide area network (WAN), a peer-to-peer network, the Internet, etc. or a combination of the above. Use of a network is contemplated but not necessarily limiting.

The host 160 may take the form of a local computer with a programmable processor and associated memory to interact with the storage device 100. In some cases, the storage device 100 may be physically located within the confines of a housing of the host, may be connected to the host, or may be remotely located from the host in which case communications between the host and the storage device take place via the network 172. In alternative embodiments, the host functionality is incorporated directly into the storage device 100, such as in the case of a network accessible storage device with its own Internet Protocol (IP) address and communication capabilities, etc.

For purposes of the present example, it is contemplated that the host 160 has a unique host identification (ID) value 174 and is operated by an authorized (human) agent who desires to download new system firmware 176 to the storage device 100. Other configurations are contemplated, including an authorized software agent, etc. The firmware download may be experienced during manufacturing processing associated with the storage device 100, during field use of the device at an end user facility, etc. It is further contemplated that the authorized agent and the host 160 are physically proximate the storage device 100, and the authorized agent has physical access to the storage device.

The storage device 100 incorporates a number of elements from the security control block 114 of FIG. 2, such as an SOC identification (ID) value 178, a public key 180 used for decryption of authentication data as explained below, and a security module 182. These elements are embedded within the SOC 110 and realized by data structures and/or programming accessed by the controller 102 (FIG. 1).

The secure server 170 includes a programmable processor with associated programming to interact with the host 160 and/or the device 100 during verification processing. The secure server 170 may include various data structures in memory such as an event log 184, one or more databases 186 storing host and SOC values, a private key 188 used for encryption of authentication data as explained below, and a security module 190 that stores and uses the private key. There may be some nexus between the secure server 170 and the authorized agent. For example, in the case where the agent is a human employee of the manufacturer of the storage devices and is tasked with loading new firmware to the device 100, the secure server 170 can be a server owned and/or operated by the device manufacturer.

Private-public key encryption is used by the system, although such is merely exemplary and is not limiting. The public-private key pair may be generated by the secure server 170 and incorporated into the SOC 110 during development.

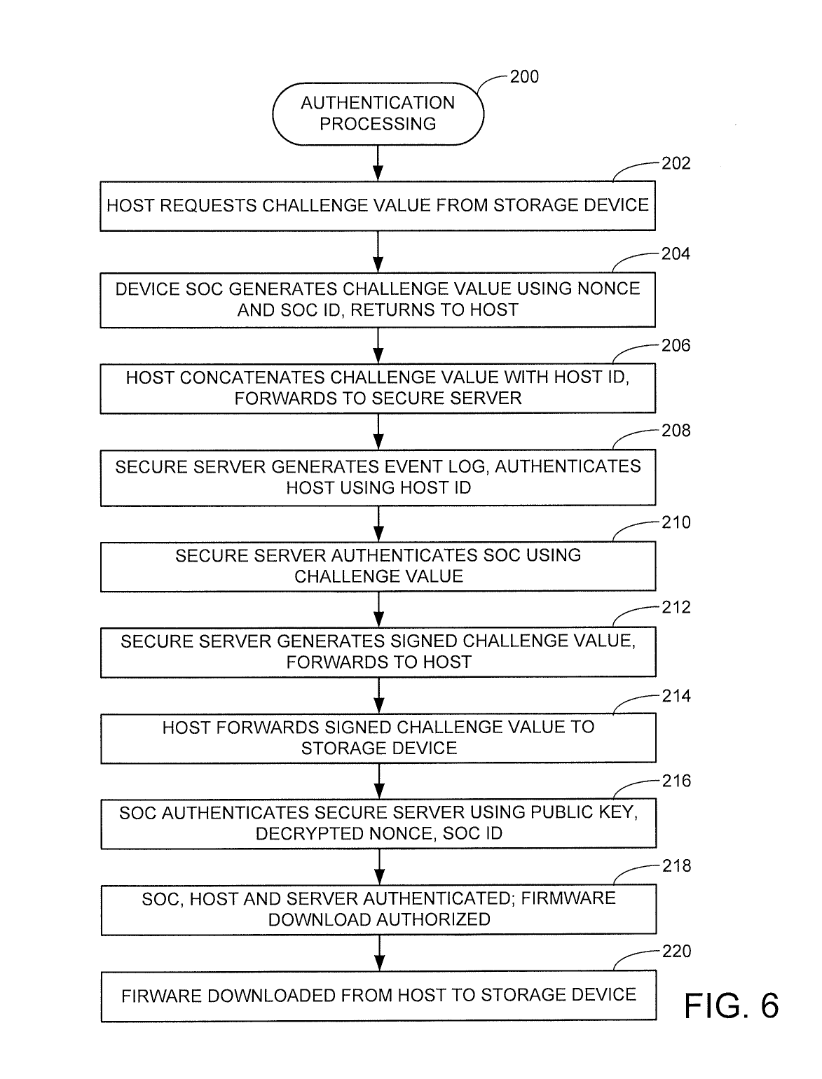

FIG. 5 provides a timing sequence diagram to describe communications between the respective host 160, storage device 100 and secure server during the authentication processing block 150 of FIG. 3. FIG. 5 commences with the authorized agent placing the storage device 100 into the bootstrap mode using the bootstrap selection mechanism 114 of FIG. 2 (e.g., placing a jumper across the associated connector pins on the device 100, etc.).

The host issues a request for a challenge value (“first authentication token”) to the storage device 100. The challenge value is a one-time, unique value used for this particular bootstrap session. The security module 182 of the storage device 100 generates the challenge value in response to the request. The challenge value can take a variety of forms. In some embodiments, the security module 182 generates a 32 byte random nonce value using a random or pseudo-random number generator and concatenates the value with the SOC ID 178. The challenge value can thus be forwarded as a plaintext verification value, although such is not necessarily required. For further security, encryption can be applied to provide the challenge value in the form of ciphertext.

The challenge value is returned to the host 160 by the storage device 100, and the host forwards the challenge value to the secure server 170 via the network 172. In some embodiments, the host 160 concatenates the challenge value with the host ID value 174. In further embodiments, the host 160 may apply cryptographic processing to the challenge value and/or the host ID value, such as through encryption, application of a digital signature, etc. At this point it will be noted that separate authentication of the host and server may take place in a variety of ways, including processes carried out prior to the generation of the challenge value by the storage device 100. These and other considerations are discussed below.

The secure server 170 receives the challenge value and the host ID value and performs a number of processing operations. The secure server logs all authentication sessions in the event log 184, and so one or more entries are generated and stored in the event log. Stored session data can include time/datestamp information, a copy of the received challenge value and host ID, IP addresses or other information associated with the communications, etc.

If the host ID is provided, the secure server 170 accesses the appropriate host database 186 to verify the host 160 is an authorized host for such transactions. It will be appreciated that host authentication is available but not necessarily required. The secure server 170 further decrypts the challenge value (if necessary) and accesses the appropriate SOC database 186 to identify the SOC ID associated with the storage device 100. It is contemplated that the SOC ID will be common to all ASICs of a certain version level, although unique SOC ID values can be generated and used for individual devices as desired.

The secure server uses the SOC ID value to identify the associated private key 188, and cryptographically processes the received challenge value using the private key to provide a digitally signed challenge value (“signature” or “second authentication token”). Other forms of encryption can be applied as desired. Successfully identifying the SOC ID value and a corresponding private key serves to authenticate the storage device.

As desired, further ID information associated with the storage device 100 can be incorporated into the challenge value. A unique serial number for the storage device can be incorporated into the challenge value and the secure server can use this to verify which device is receiving the requested FW update. Hidden values unique to the storage device can be embedded within the SOC 110, such as in the boot code, and used for such verification at the secure server level.

The digitally signed challenge value is returned via the network 172 to the host 160, which transfers the same to the storage device 100. The security module 182 decrypts the digitally signed challenge value and compares the original contents (nonce, SOC ID, etc.) to what was originally forwarded to the host. If these contents are the same, the storage device 100 authenticates the secure server 170 as an authorized agent and forwards a firmware download authorization communication to the host 160. In response, the host transfers the new firmware (FW) 176 to the storage device 100.

In some cases, the host 160 and the storage device 100 may be configured such that the new firmware (FW) 176 is downloaded to the storage device 100 prior to the authentication process. The storage device 100 maintains the new firmware in a quarantined location until authorization is successful. If the authorization process fails, the storage device rejects the new firmware and proceeds with the last known good firmware (e.g., 118, FIG. 2).

In further cases, multiple stages of verification processing can be employed such as in the situation where higher levels of security are required. For example, the general sequence of FIG. 5 can be carried out initially to authenticate the storage device, host and secure server to one another. Thereafter, the transferred firmware (or other control information) can be separately subjected to similar processing. For example, certain marker information embedded within the downloaded firmware may be forwarded in a subsequent encrypted challenge value back to the server, so that the server verifies the specific content that was downloaded to the storage device. Other variations and alternatives will readily occur to the skilled artisan in view of the present disclosure.

A variety of techniques can be employed for host enrollment and provisioning which are carried out prior to the processing of the challenge values. Such techniques may involve separate authentication steps that will readily occur to the skilled artisan in view of this disclosure. This can reduce efforts by unauthorized parties to counterfeit (spoof) valid host devices.

Once enrolled, a particular host can be authenticated for a particular session by appending the host ID to the first authentication token and then use the host's private key to sign, or the server's public key to encrypt, or use a host-server shared secret key to encrypt before transmission to the server. In further embodiments, a secure data communication link between the host and the server can be formed and used to transmit the respective communications between the host and the server.

In further embodiments, separate authentication can be carried out at the agent level (e.g., human operator, software module, etc.) in a variety of ways. Depending on the level of desired security, biometrics can be included in the agent authentication process. Thus, authentication can be carried out host to server, server to storage device, and agent to server.

FIG. 6 provides a flow chart for an AUTHENTICATION PROCESSING routine 200 to summarize the foregoing discussion. The flow chart is directed to the authentication processing block 150 from FIG. 3, and will be discussed in terms of the example of FIGS. 4-5. It will be appreciated that the routine 200 is merely exemplary and the various steps shown therein can be modified, omitted and/or performed in a different order, and additional steps can be added as required.

Upon placement of the device 100 into bootstrap mode, the host 160 requests a challenge value from the storage device 100 at step 202. The storage device 100 generates the challenge value such as through a random nonce and SOC ID information, and returns the challenge value to the host at 204. The host concatenates HOST ID information and forwards to the secure server at step 206.

At step 208, the secure server generates an event log entry to record authentication session data, and authenticates the host using the HOST ID. The secure server identifies the storage device 100 at step 210 by using the SOC ID to identify the private key. Other storage device authentication steps can be used here as well. For example, if the challenge value is in the form of ciphertext, the secure server decrypts the same. If the challenge value incorporates a unique ID value that is different for each storage device, the secure server authenticates on that basis as well.

At step 212, the secure server 170 generates the signed challenge value using the private key and forwards the signed challenge value to the host 160. The host forwards the signed challenge value to the storage device at step 214, and the SOC authenticates the secure server by decrypting the digitally signed challenge value and comparing the contents with the original contents of the challenge value at step 216.

At this point, each of the SOC, the host and the server have been authenticated, and the downloading/use of new replacement firmware is authorized at step 218. The firmware is downloaded, unlocked or otherwise made available to the system at step 220. While not shown in FIG. 6, further processing steps may include the execution of the new firmware by the controller and the transition to a normal operational mode using the same, as discussed above in FIG. 3.

The bootstrap functionality and authentication features of the foregoing embodiments can enable authorized agents to securely and efficiently access and modify storage device configurations. In some cases, problems with existing firmware stored in a given storage device may not enable the device to respond to normal firmware upgrade operations. Accordingly, forcing the storage device into the bootstrap mode can provide a mechanism in which new firmware can be safely and securely loaded to address such problems. Requiring authentication of both host and secure server levels further assures that malicious parties cannot easily load malicious firmware to gain access to sensitive user data or other aspects of the storage device.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A data storage device comprising:
a main memory which stores user data from a host; and
a controller having initialization programming stored in a boot memory executed by the controller to transition the data storage device from an inactive state to an active state, wherein during a bootstrap mode of the initialization programming the controller generates a first authentication token, receives a second authentication token responsive to the first authentication token, and authorizes use of new system programming responsive to the second authentication token, wherein the new system programming is stored in a local memory of the data storage device and executed by the controller to direct a transfer of the user data from the main memory to the host.

2. The data storage device of claim 1, further comprising a bootstrap select mechanism having an inactive position and an active position, wherein the controller generates the first authentication token responsive to a user of the data storage device placing the bootstrap select mechanism in the active position.

3. The data storage device of claim 2, wherein the bootstrap select mechanism comprises an electrically conductive jumper that is placed into contacting engagement with a pair of conductive pins.

4. The data storage device of claim 1, wherein the main memory stores older system programming executable by the controller during a normal operational mode of the data storage device, and wherein the new system programming is authorized for use by the controller in lieu of the older system programming responsive to a content of the second authentication token matching a content of the first authentication token.

5. The data storage device of claim 1, wherein the first authentication token comprises a challenge value generated by the controller in the form of plaintext, and wherein the second authentication token comprises the challenge value to which encryption has been applied so that the second authentication token is in the form of ciphertext.

6. The data storage device of claim 5, wherein the controller applies decryption to the second authentication token to recover the originally generated challenge value.

7. The data storage device of claim 5, wherein the challenge value comprises a system on chip identification (SOC ID) value associated with the controller.

8. The data storage device of claim 1, wherein the main memory comprises at least a selected one of rotatable magnetic recording media or solid-state flash memory.

9. The data storage device of claim 1 in conjunction with a host and a secure server, wherein the data storage device forwards the first authentication token to the host, wherein the host forwards the first authentication token and host identification (HOST ID) data associated with the host to the secure server via a computer network, wherein the secure server authenticates the host using the HOST ID data, authenticates the data storage device using the first authentication token, and encrypts the first authentication token to generate the second authentication token.

10. A data storage device comprising a main memory adapted to store user data from a host, and a controller having system programming stored in a local memory and executed by the controller during a normal operational mode to direct data access operations with the main memory, the controller further having initialization programming stored in a boot memory and executed by the controller during system initialization to transition the data storage device from an inactive state to the normal operational mode, wherein during execution of the initialization programming the controller enters a bootstrap mode, generates a first authentication token, receives a second authentication token responsive to the first authentication token, and authenticates new system programming for use during the normal operational mode responsive to the second authentication token.

11. The data storage device of claim 10, further comprising a bootstrap select mechanism having an inactive position and an active position, wherein the controller generates the first authentication token responsive to a user of the data storage device placing the bootstrap select mechanism in the active position prior to or during execution of the initialization programming by the controller.

12. The data storage device of claim 10, wherein the first authentication token comprises a challenge value generated by the controller comprising hidden content associated with the data storage device, and wherein the second authentication token comprises the challenge value to which encryption has been applied so that the second authentication token is in the form of ciphertext.

13. The data storage device of claim 12, wherein the controller applies decryption to the ciphertext of the second authentication token to obtain a recovered challenge value, and compares the recovered challenge value to the originally generated challenge value to authenticate the new system programming.

14. A computer implemented method comprising:
using a controller of a data storage device to execute initialization programming stored in a boot memory to transition the data storage device from an inactive state to a normal operational mode;
generating a first authentication token;
receiving a second authentication token responsive to the first authentication token;
authenticating new system programming responsive to the second authentication token, the new system programming stored in a local memory; and
using the controller to execute the new system programming to direct a transfer of user data between a main memory of the data storage device and a host during the normal operational mode.

15. The computer implemented method of claim 14, further comprising entering a bootstrap mode during execution of the initialization programming, wherein the generating, receiving and authenticating steps are performed during the bootstrap mode.

16. The computer implemented method of claim 15, wherein the bootstrap mode is entered responsive to user selection of a bootstrap select mechanism coupled to the data storage device.

17. The computer implemented method of claim 14, wherein the first authentication token comprises a challenge value generated by the controller in the form of plaintext, and wherein the method further comprises generating the second authentication token by applying encryption to the challenge value so that the second authentication token is in the form of ciphertext.

18. The computer implemented method of claim 18, further comprising decrypting the second authentication token to obtain a recovered challenge value, and comparing the recovered challenge value to the generated challenge value to authenticate the new system programming.

19. The computer implemented method of claim 14, wherein the first authentication token comprises system on chip identification (SOC ID) data associated with the controller.

20. The computer implemented method of claim 14, wherein the main memory comprises at least a selected one of rotatable magnetic recording media or solid-state flash memory.
